(19) United States
(12) Patent Application Publication
(10) Pub. No.: US 2024/0173870 A1
(43) Pub. Date: May 30, 2024

(54) MODULAR FINGERTIPS FOR SOFT ROBOTIC ACTUATORS

(71) Applicant: SOFT ROBOTICS, INC., Bedford, MA (US)

(72) Inventor: Michael BASSETT, Bedford, MA (US)

(21) Appl. No.: 18/524,901

(22) Filed: Nov. 30, 2023

Related U.S. Application Data
(60) Provisional application No. 63/428,994, filed on Nov. 30, 2022.

(51) Int. Cl. B25J 15/00; B25J 9/14; B25J 15/04

(52) U.S. Cl. CPC B25J 15/0023; B25J 9/142; B25J 15/0475

(57) ABSTRACT

Exemplary embodiments pertain to soft robotic actuators configured to receive modular fingertips. The fingertips may be provided at the distal end of a standardized actuator. The actuator's distal tip may be sized and shaped to correspond to a proximal end of the modular fingertip. A backing plate may be provided in a reservoir of the actuator in order to spread the load of a fastener that can be inserted through the reservoir and backing plate and into one or more holes that pass through the material of the actuator and into the modular fingertip. For purposes of reducing bacterial harborage points, the holes may extend only partway through the modular fingertip without extending entirely through it. In other embodiments, the fastener may be inserted into the fingertip and secured to the actuator. A sealing bead may be provided between the distal tip of the actuator and the fingertip.

### CROSS-REFERENCE TO RELATED APPLICATIONS

This application claims the benefit of U.S. Provisional Patent Application No. 63/428,994, filed Nov. 30, 2022, entitled “MODULAR FINGERTIPS FOR SOFT ROBOTIC ACTUATORS”, the entire contents of which are incorporated by reference herein.

### BACKGROUND

Robotic grippers are used in a wide variety of applications, such as packaging, manufacturing, food preparation, and other fields. Many robotic grippers have historically been made of hard or otherwise non-compliant materials, but recently “soft” elastomeric robotic actuators (or fingers) have become widely available. Soft actuators have an advantage over hard actuators in that they can conform to the target object being manipulated. This means that one robotic actuator can be used to securely grasp target objects of a wide variety of shapes, sizes, and weights without damaging them—a balance that is difficult for a hard gripper to achieve.

However, a problem still exists in that different tasks may benefit from actuators having different geometries or configurations. For example, when picking a target object out of a tightly packed environment, it may be useful to have a robotic finger with a relatively flat end that can be used to separate or isolate the target object from its neighbors. On the other hand, a different style of actuator with a high-friction gripping surface might be better suited to picking up objects in slippery bags. While it is possible to design soft actuators of different styles or configurations, in practice the end user needs to swap out the entire actuator when changing to a new gripping task. This can be both expensive (in that the user needs to maintain many copies of complete specialized actuators) and time-consuming. To avoid these costs users may be inclined to rely on a single general-purpose actuator style, but this may make it more difficult to pick up certain types of objects, potentially resulting in dropped items and reducing throughput.

In addition to being difficult to implement for the end user, customized soft robotic fingertips can be expensive for manufacturers to produce. Conventionally, soft robotic actuators are formed from a material that is poured into a mold corresponding to the desired shape of the actuator. Producing custom actuators typically requires separate, new molds for each actuator configuration, which increases the price and complexity of the manufacturing process. Consequently, development of new tools may be limited to those required by large companies, since it may not be financially viable to iteratively create new molds while designing a new actuator if sales of the actuator are not predicted to be of high volume. Smaller or more specialized operators may therefore be limited in their selection of custom tools to the tools developed for their larger competitors.

### BRIEF SUMMARY

Exemplary embodiments provide soft robotic actuators configured to mate with a modular fingertips that can provide interchangeable capabilities that can be swapped out quickly and efficiently. Further embodiments relate to methods of deploying and using systems including the actuator and modular tip.

In one aspect, a soft robotic actuator system includes a soft robotic actuator includes an elastomeric material extending from a proximal end to a distal end and substantially surrounding a reservoir configured to receive an inflation fluid, the soft robotic actuator configured to bend in a circumferential direction upon adding the inflation fluid to, or removing the inflation fluid from, the reservoir, where the distal end of the actuator is sized and shaped to mate with a proximal end of a modular fingertip configured to be secured onto the distal end of the actuator, and the distal end includes one or more holes configured to receive a fastener that mates with the modular fingertip.

The soft robotic actuator system may also include further includes the modular fingertip.

The soft robotic actuator system may also include where the one or more holes of the distal end do not extend completely through the elastomeric material of the soft robotic actuator.

The soft robotic actuator system may also include further includes a backing plate configured to secure the proximal end of the modular fingertip to the distal end of the actuator.

The soft robotic actuator system may also include further includes an ingress seal bead configured to protect an interface between the proximal end of the modular fingertip and the distal end of the actuator.

The soft robotic actuator system may also include where the modular fingertip is a spatula having a substantially flat surface that extends away from the soft robotic actuator along a plane defined by a base of the soft robotic actuator.

The soft robotic actuator system may also include where the modular fingertip includes an angled tip that extends away from the soft robotic actuator at an angle to a plane defined by a base of the soft robotic actuator.

The soft robotic actuator system may also include where the modular fingertip includes a surface that is textured so as to increase a friction applied by the modular fingertip as compared to a base of the soft robotic actuator.

The soft robotic actuator system may also include where the modular fingertip includes a flat extension with a flat surface that extends away from the soft robotic actuator along a plane defined by a base of the soft robotic actuator, where the flat extension either tapers or expands along a length of the flat extension.

The soft robotic actuator system may also include where the modular fingertip is a first modular fingertip that connects to a second adjacent modular finger via inter-fingertip webbing.

Another embodiment relates to a method that includes accessing a soft robotic actuator as described above, and securing the modular fingertip to the distal end of the actuator with a fastener.

Securing the modular fingertip may include inserting an installation tool into the proximal end of the actuator. The installation tool may have a length greater than a length of the actuator and a width smaller than a width of the reservoir. Inserting the installation tool into the proximal end of the actuator may include lowering the actuator onto the installation tool.

The method may also include inserting a backing plate into the reservoir of the soft robotic actuator prior to securing the modular fingertip with the fastener.

The fastener may be driven through a hole in the backing plate that is matched to a hole in the actuator.

Securing the modular fingertip to the distal end of the actuator may include inserting the fastener into a hole in the modular fingertip and tightening the fastener.

The method may also include installing an ingress seal between the fastener and the modular fingertip.

Accessing the actuator may include removing the actuator from a robotic gripper prior to securing the modular fingertip, and/or securing the actuator to a robotic gripper after securing the modular fingertip.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A-FIG. 1D depict exemplary soft actuators and inflation systems in accordance with exemplary embodiments.

FIG. 2 is a cross-sectional perspective view of a soft actuator with a modular fingertip installed in accordance with one embodiment.

FIG. 3A-FIG. 3D depict views of exemplary actuators with modular fingertips installed.

FIG. 4A-FIG. 4D depict views of exemplary actuators suitable for use with modular fingertips.

FIG. 5A-FIG. 5F depict various examples of modular fingertips suitable for use with exemplary embodiments.

FIG. 6 is an exemplary flowchart describing a technique for installing a modular fingertip according to exemplary embodiments.

### DETAILED DESCRIPTION

The present invention will now be described more with reference to the accompanying drawings, in which preferred embodiments of the invention are shown. The invention, however, may be embodied in many different forms and should not be construed as being limited to the embodiments set forth herein. Rather, these embodiments are provided so that this disclosure will be thorough and complete, and will fully convey the scope of the invention to those skilled in the art.

In the drawings, like numbers refer to like elements throughout. Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

### Background on Soft Robotic Grippers

Conventional robotic grippers or actuators may be expensive and incapable of operating in certain environments where the uncertainty and variety in the weight, size and shape of the object being handled has prevented automated solutions from working in the past. The present application describes applications of novel soft robotic actuators that are adaptive, inexpensive, lightweight, customizable, and simple to use.

Soft robotic actuators may be formed of elastomeric materials, such as rubber, or thin walls of plastic arranged in an accordion structure that is configured to unfold, stretch, and/or bend under pressure, or other suitable relatively soft materials. They may be created, for example, by molding one or more pieces of the elastomeric material into a desired shape. Soft robotic actuators may include a hollow interior that can be filled with a fluid, such as air, water, or saline to pressurize, inflate, and/or actuate the actuator. Upon actuation, the shape or profile of the actuator changes. In the case of an accordion-style actuator (described in more detail below), actuation may cause the actuator to curve or straighten into a predetermined target shape. One or more intermediate target shapes between a fully unactuated shape and a fully actuated shape may be achieved by partially inflating the actuator. Alternatively or in addition, the actuator may be actuated using a vacuum to remove inflation fluid from the actuator and thereby change the degree to which the actuator bends, twists, and/or extends.

Actuation may also allow the actuator to exert a force on an object, such as an object being grasped or pushed. However, unlike traditional hard robotic actuators, soft actuators maintain adaptive properties when actuated such that the soft actuator can partially or fully conform to the shape of the object being grasped. They can also deflect upon collision with an object, which may be particularly relevant when picking an object off of a pile or out of a bin, since the actuator is likely to collide with neighboring objects in the pile that are not the grasp target, or the sides of the bin. Furthermore, the amount of force applied can be spread out over a larger surface area in a controlled manner because the material can easily deform. In this way, soft robotic actuators can grip objects without damaging them.

Moreover, soft robotic actuators allow for types of motions or combinations of motions (including bending, twisting, extending, and contracting) that can be difficult to achieve with traditional hard robotic actuators.

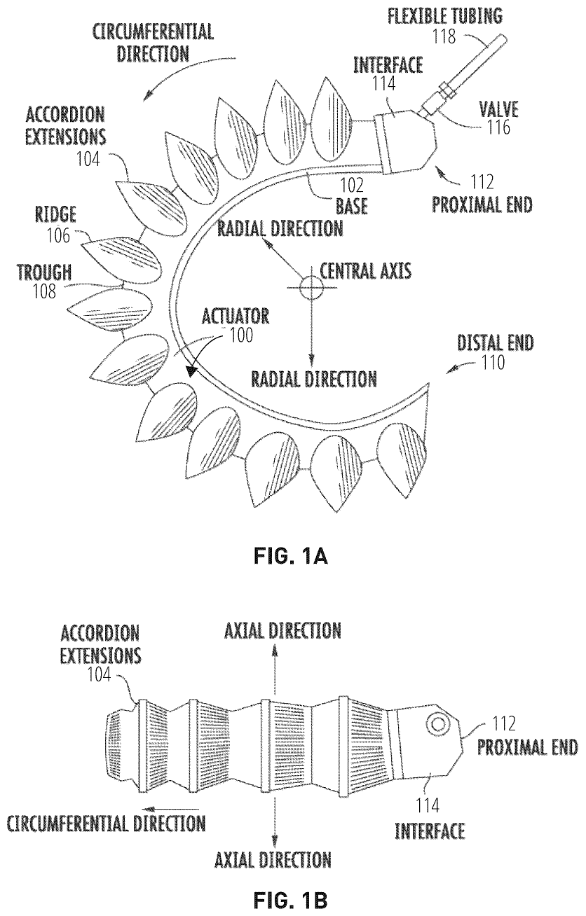

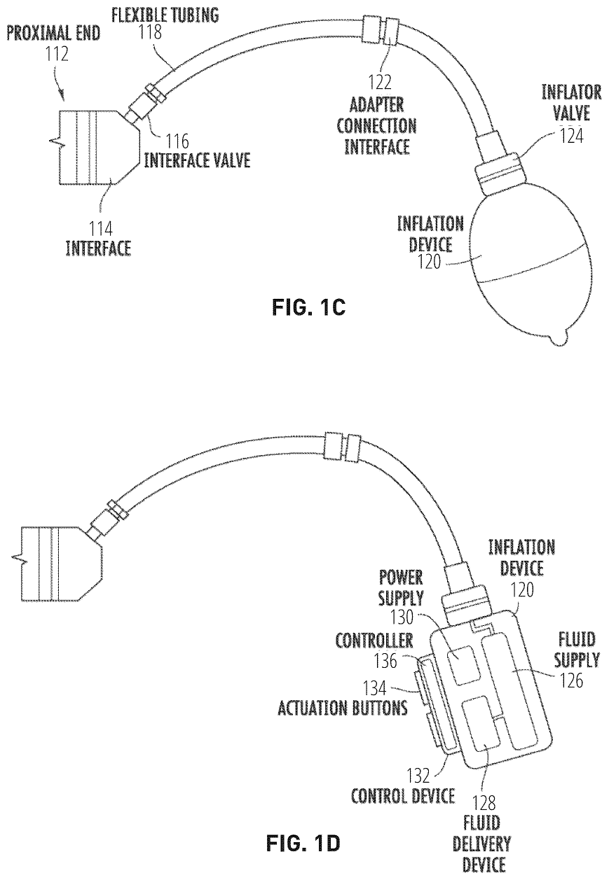

FIG. 1A-FIG. 1D depict exemplary soft robotic actuators. More specifically, FIG. 1A depicts a side view of a portion of a soft robotic actuator 100. FIG. 1B depicts the portion from FIG. 1A from the top. FIG. 1C depicts a side view of a portion of the soft robotic actuator 100 including a pump that may be manipulated by a user. FIG. 1D depicts an alternative embodiment for the portion depicted in FIG. 1C.

An actuator 100 may be a soft robotic actuator, as depicted in FIG. 1A, which is inflatable with an inflation fluid such as air, water, or saline. The inflation fluid may be provided via an inflation device 120 through a fluidic connection such as flexible tubing 118.

The actuator 100 may be in an uninflated state in which a limited amount of inflation fluid is present in the actuator 100 at substantially the same pressure as the ambient environment. The actuator 100 may also be in a fully inflated state in which a predetermined amount of inflation fluid is present in the actuator 100 (the predetermined amount corresponding to a predetermined maximum force to be applied by the actuator 100 or a predetermined maximum pressure applied by the inflation fluid on the actuator 100). The actuator 100 may also be in a full vacuum state, in which all fluid is removed from the actuator 100, or a partial vacuum state, in which some fluid is present in the actuator 100 but at a pressure that is less than the ambient pressure. Furthermore, the actuator 100 may be in a partially inflated state in which the actuator 100 contains less than the predetermined amount of inflation fluid that is present in the fully inflated state, but more than no (or very limited) inflation fluid.

In the inflated state, the actuator 100 may exhibit a tendency to curve around a central axis as shown in FIG. 1A. For ease of discussion, several directions are defined herein. An axial direction passes through the central axis around which the actuator 100 curves, as shown in FIG. 1B. A radial direction extends in a direction perpendicular to the axial direction, in the direction of the radius of the partial circle formed by the inflated actuator 100. A circumferential direction extends along a circumference of the inflated actuator 100.

In the inflated state, the actuator 100 may exert a force in the radial direction along the inner circumferential edge of the actuator 100. For example, the inner side of the distal tip of the actuator 100 exerts a force inward, toward the central axis, which may be leveraged to allow the actuator 100 to grasp an object (potentially in conjunction with one or more additional actuators 100). The soft robotic actuator 100 may remain relatively conformal when inflated, due to the materials used and the general construction of the actuator 100.

In a neutral state, the base 102 of the actuator 100 may be substantially straight. In this case, the base 102 defines a plane that can be extended out from the actuator along a length and/or width of the base.

The actuator 100 may be made of one or more elastomeric materials that allow for a relatively soft or conformal construction. Depending on the application, the elastomeric materials may be selected from a group of food-safe, biocompatible, or medically safe, FDA-approved materials. The actuator 100 may be manufactured in a Good Manufacturing Process (“GMP”)-capable facility.

The actuator 100 may include a base 102 that is substantially flat (although various amendments or appendages may be added to the base 102 in order to improve the actuator's gripping and/or bending capabilities). The base 102 may form a gripping surface that grasps a target object. In some embodiments, the base may be made of a different material or of a different thickness than the remainder of the actuator 100 and/or may include features such as slats that extend in the axial direction. The material properties or additional features may program a bending resistance into the base 102 (which may be different from the bending resistance of the remainder of the actuator 100) that causes the actuator 100 to preferentially bend in the circumferential direction. In some embodiments, the actuator 100 may exhibit a substantially linear bending profile, in that the actuator 100 responds to an increased or decreased pressure by changing its curvature by approximately the same amount over a relatively wide variety of pressurization values (e.g., 0 to 15 psi). In other embodiments, the strain may be programmed to vary in a predetermined and predictable way over certain portions of the actuator's operating range, and/or may cause the actuator 100 to twist or curl in any of the axial, circumferential, and/or radial directions.

The actuator 100 may include one or more accordion extensions 104. The accordion extensions 104 allow the actuator 100 to bend or flex when inflated, and help to define the shape of the actuator 100 when in an inflated state. The accordion extensions 104 include a series of ridges 106 and troughs 108. The size of the accordion extensions 104 and the placement of the ridges 106 and troughs 108 can be varied to obtain different shapes or extension profiles.

Although the exemplary actuator of FIGS. 1A-1D is depicted in a “C” or oval shape when deployed, one of ordinary skill in the art will recognize that the present invention is not so limited. By changing the shape of the body of the actuator 100, or the size, position, or configuration of the accordion extensions 104, different sizes, shapes, and configurations may be achieved. Moreover, varying the amount of inflation fluid provided to the actuator 100 allows the actuator 100 to take on one or more intermediate sizes or shapes between the un-inflated state and the inflated state. Thus, an individual actuator 100 can be scalable in size and shape by varying inflation amount, and an actuator can be further scalable in size and shape by replacing one actuator 100 with another actuator 100 having a different size, shape, or configuration.

The actuator 100 extends from a proximal end 112 to a distal end 110. The proximal end 112 connects to an interface 114. The interface 114 allows the actuator 100 to be releasably coupled to other parts of the actuator 100. The interface 114 may be made of a medically- or food-safe material, such as polyethylene, polypropylene, polycarbonate, polyetheretherketone, acrylonitrile-butadiene-styrene (“ABS”), or acetal homopolymer. The interface 114 may be releasably coupled to one or both of the actuator 100 and the flexible tubing 118. The interface 114 may have a port for connecting to the actuator 100. Different interfaces 114 may have different sizes, numbers, or configurations of actuator ports, in order to accommodate larger or smaller actuators, different numbers of actuators, or actuators in different configurations.

The actuator 100 may be inflated with an inflation fluid supplied from an inflation device 120 through a fluidic connection such as flexible tubing 118. The interface 114 may include or may be attached to a valve 116 for allowing fluid to enter the actuator 100 but preventing the fluid from exiting the actuator (unless the valve is opened). The flexible tubing 118 may also or alternatively attach to an inflator valve 124 at the inflation device 120 for regulating the supply of inflation fluid at the location of the inflation device 120.

The flexible tubing 118 may also include an actuator adapter connection interface 122 for releasably connecting to the interface 114 at one end and the inflation device 120 at the other end. By separating the two parts of the actuator adapter connection interface 122, different inflation devices 120 may be connected to different interfaces 114 and/or actuators 100.

The inflation fluid may be, for example, air or saline. In the case of air, the inflation device 120 may include a hand-operated bulb or bellows for supplying ambient air. In the case of saline, the inflation device 120 may include a syringe or other appropriate fluid delivery system. Alternatively or in addition, the inflation device 120 may include a compressor or pump for supplying the inflation fluid.

The inflation device 120 may include a fluid supply 126 for supplying an inflation fluid. For example, the fluid supply 126 may be a reservoir for storing compressed air, liquefied or compressed carbon dioxide, liquefied or compressed nitrogen or saline, or may be a vent for supplying ambient air to the flexible tubing 118.

The inflation device 120 further includes a fluid delivery device 128, such as a pump or compressor, for supplying inflation fluid from the fluid supply 126 to the actuator 100 through the flexible tubing 118. The fluid delivery device 128 may be capable of supplying fluid to the actuator 100 or withdrawing the fluid from the actuator 100. The fluid delivery device 128 may be powered by electricity. To supply the electricity, the inflation device 120 may include a power supply 130, such as a battery or an interface to an electrical outlet.

The power supply 130 may also supply power to a control device 132. The control device 132 may allow a user to control the inflation or deflation of the actuator, e.g. through one or more actuation buttons 134 (or alternative devices, such as a switch). The control device 132 may include a controller 136 for sending a control signal to the fluid delivery device 128 to cause the fluid delivery device 128 to supply inflation fluid to, or withdraw inflation fluid from, the actuator 100. The controller 136 may be programmed with suitable logic or instructions encoded on a non-transitory computer-readable medium for performing the procedures described herein.

### Actuators and Modular Fingertips

Exemplary embodiments relate to specialized soft robotic actuators and the modular fingertips capable of being attached to them. Using these modular fingertips and a connection mechanism as described below, actuators can be configured with different capabilities and functionality without the need to deploy an entirely new, specialized actuator for each different task.

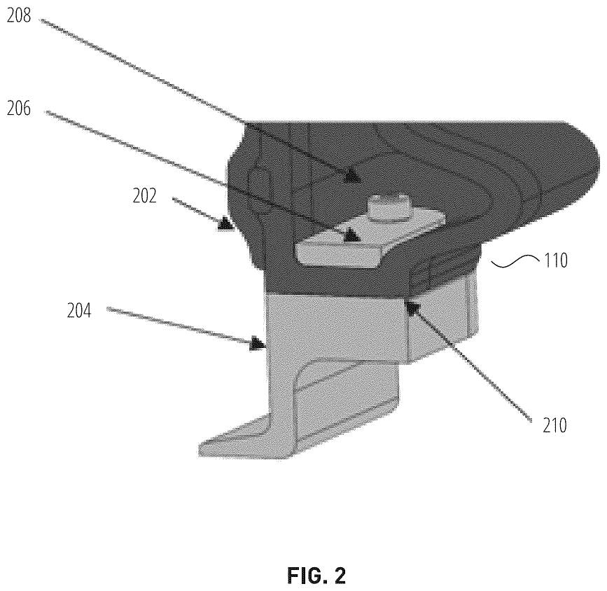

FIG. 2 is a close up of the distal end 110 of such an actuator 202, to which a modular fingertip 204 has been affixed. The distal end 110 of the actuator 202 and the proximal end of the modular fingertip 204 are configured with corresponding shapes. For example, in FIG. 2 the distal end 110 is flattened (as compared to, for example, the actuator 100) so as to accommodate the flat proximal end of the modular fingertip 204. Although the depicted embodiment mates two flat surfaces together, one of ordinary skill will understand that other configurations are also possible.

The modular fingertip 204 may be formed of an elastomeric or non-elastomeric material. For instance, the modular fingertip 204 may be made from silicon rubber. In some embodiments, the modular fingertip 204 may be made from a food-grade material, such as Delrin or another hard plastic.

To secure the modular fingertip 204 to the actuator 202, a backing plate 206 may be inserted into the reservoir of the actuator 202 and positioned on the internal side of the distal end 110. The backing plate 206 in this example is a flat plate sized and shaped to fit securely in the distal end 110 of the actuator 202. The backing plate 206 includes one or more through-holes to accommodate blind screws 208, which can be inserted from the inside of the actuator 202, through the reservoir and the backing plate 206, then through corresponding holes in the actuator 202 and into the modular fingertip 204. In this way, the modular fingertip 204 can be secured to the actuator 202. The backing plate may have a surface that extends to fill all the available space on the interior bottom of the distal end 110 of the actuator 202, so as to better spread out the load from the blind screw 208 and reduce the wear and tear on the actuator 202.

The blind screw 208 may be secured through the backing plate 206 using a special tool, such as an especially long allen wrench. To fasten the blind screw 208, the actuator 202 may be lowered onto the installation tool so that the installation tool is inserted into the reservoir of the actuator 202. The installation tool may be brought into contact with the blind screw 208 and rotated until the blind screw 208 is secured through the backing plate 206, the actuator 202, and the modular fingertip 204.

In some applications (such as food handling and similar contexts), it may be important to reduce or eliminate bacterial harborage points. The interface between the actuator 202 and modular fingertip 204 may be a particularly vulnerable point for the intrusion of bacteria or other materials. Accordingly, in some embodiments the actuator 202 and/or the modular fingertip 204 may be provided with an ingress seal bead 210. For instance, the outer perimeter of the distal end 110 of the actuator 202 include a bead, rib, rim or compressible area that, when the actuator 202 is tightened against the modular fingertip 204 using the blind screws 208, forms a seal that prevents ingress of target materials into the interface between the actuator 202 and modular fingertip 204. In some embodiments, a separate sealing device, such as an o-ring, gasket, or similar mechanism, may be provided at this interface.

As another defense against bacterial intrusion, the holes for the blind screw 208 may extend through the backing plate 206 and the actuator 202, and then partially through the modular fingertip 204 without extending all the way through the modular fingertip 204. Thus, there may be no openings on the outward-facing part of the modular fingertip 204 that could harbor bacteria or allow for the entry of other materials.

In an alternative embodiment, the blind screw 208 may be inserted in the opposite manner, from the outside of the actuator 202/modular fingertip 204 system and into the backing plate 206 in the interior of the actuator 202. This has the advantage of simpler and faster installation/removal, since the installation tool need not be inserted into the reservoir of the actuator 202. However, it may also introduce openings through which bacteria or other materials may intrude. Accordingly, a sealing surface may be added to the blind screw 208 in a similar manner to the ingress seal bead 210. The style or type of blind screw 208 may also be selected so as to reduce the number of hard edges or sharp angles on the blind screw 208.

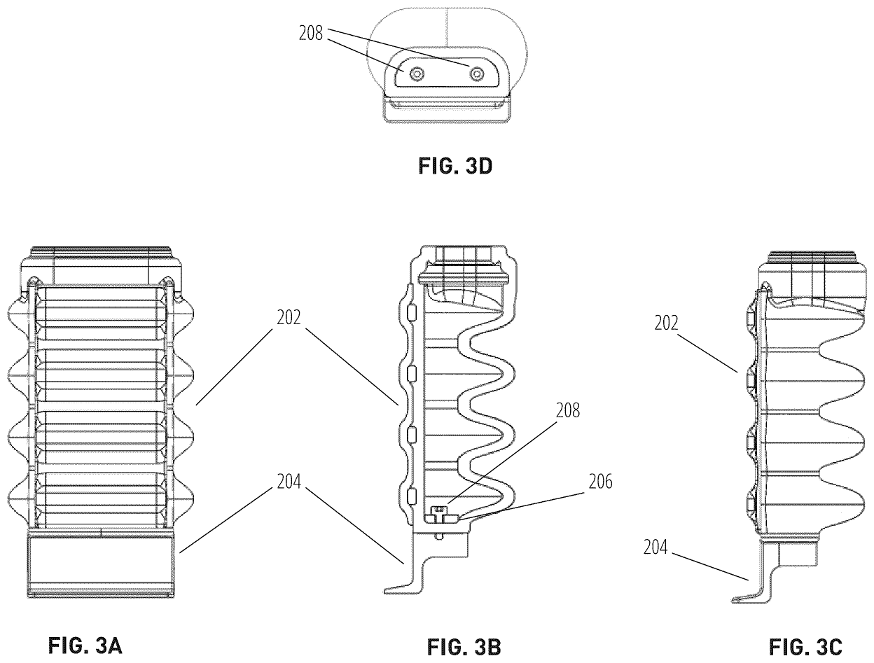

For reference, FIG. 3A-FIG. 3D are elevation views showing the base (FIG. 3A), side cross-section (FIG. 3B), side (FIG. 3C) and top (FIG. 3D) of the actuator 202 with the modular fingertip 204 attached.

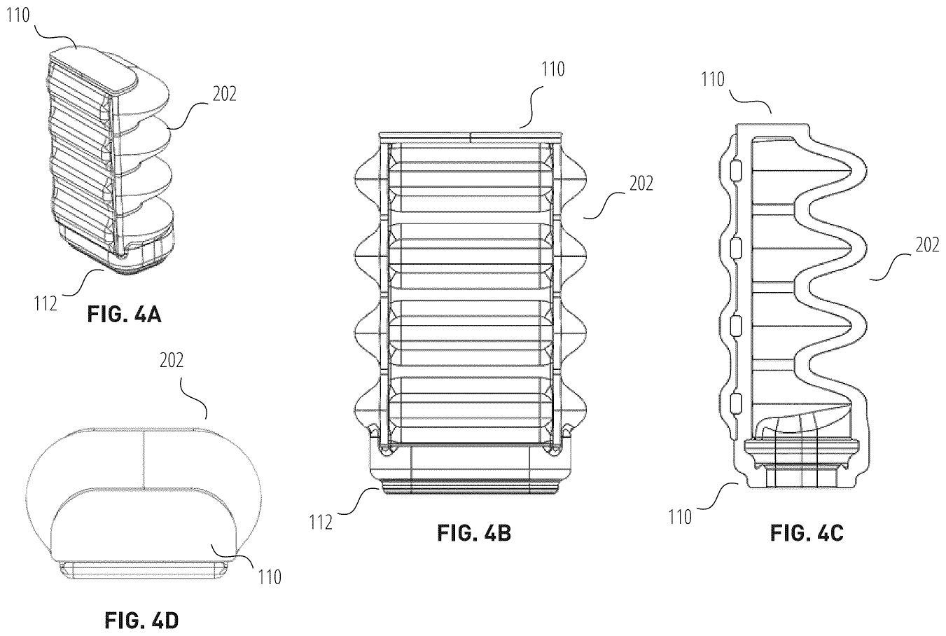

Similarly, FIG. 4A-FIG. 4D are perspective (FIG. 4A), rear (FIG. 4B), side cross-section (FIG. 4C) and top (FIG. 4D) views of the actuator 202 without an attached modular fingertip 204.

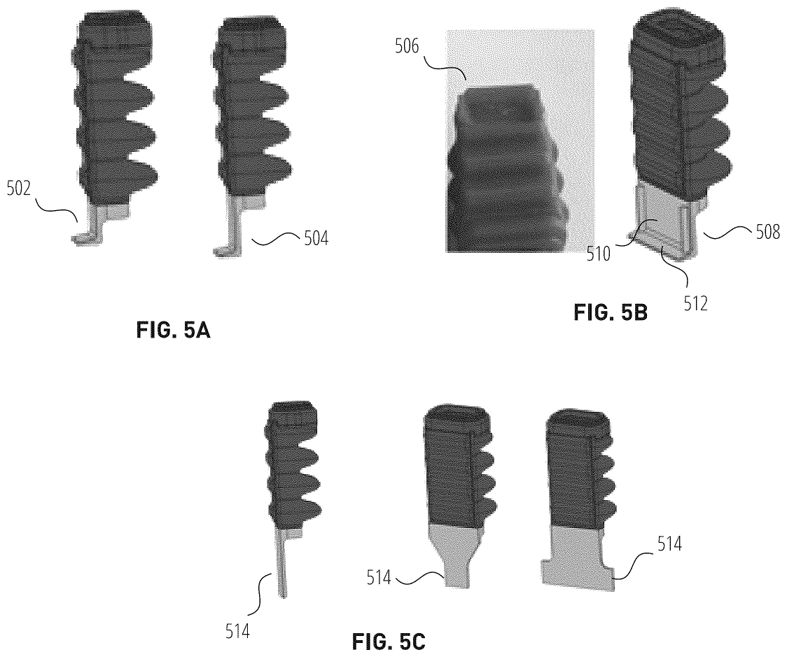

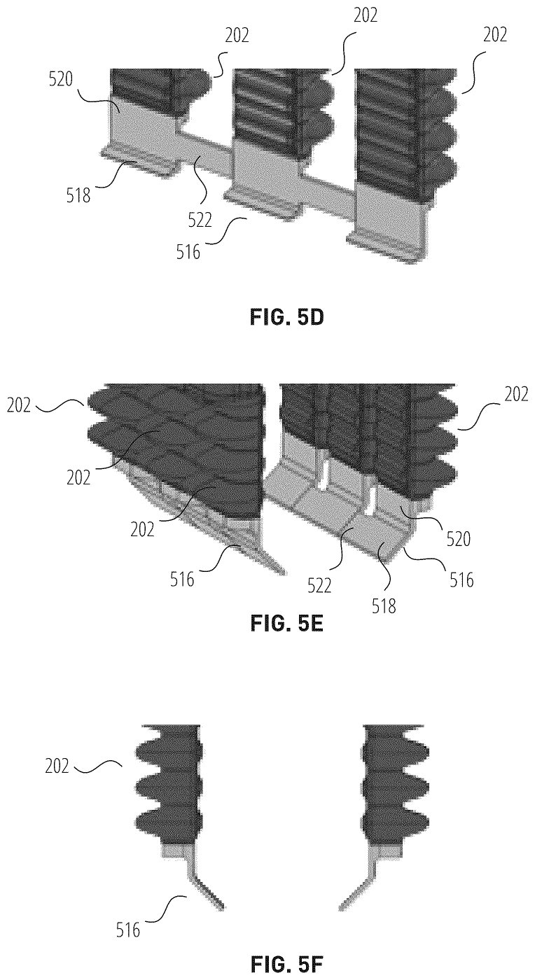

FIG. 5A-FIG. 5F depict some examples of modular fingertips suitable for use with exemplary embodiments for different applications.

FIG. 5A depicts two examples of angled tips 502: a short tip (left) and a long tip (right). The angled tips each include an extension that extends away from the distal end 110 of the actuator 202 along a plane defined by a base of the soft robotic actuator (e.g., serving as an extension to the base). An angled tip extends away from the soft robotic actuator at an angle to the plane. FIG. 5A depicts tips extending away from the plane at a 90 degree angle, although other embodiments may utilize 45 degree angles, 30 degree angles, or any other angle suitable to the application.

Such a tip provides an improved gripping surface for picking up slippery objects such as raw chicken. If the extension is sufficiently long (e.g., at least 10% of the length of the base 102 of the actuator 202, preferably at least 20% of the length of the base 102, more preferably at least 25% of the length of the base 102), the tip can also serve as a spatula 504 for picking up food articles and other items.

FIG. 5B depicts two examples of nubs that serve similar purposes to the angled tips 502. In the left drawing, a soft (elastomeric) nub 506 is affixed to the actuator 202, which can provide increased friction or gripping capabilities for slippery and/or deformable items such as plastic poly bags. The nub 506 may extend a relatively short distance (e.g., 10% or less of the length of the base 102). In some embodiments, a base of the nub 506 (on the same side as the base 102) may be slightly recessed and/or may be textured so as to increase a friction applied by the modular fingertip as compared to a base of the soft robotic actuator or an untextured surface.

In the right drawing, a rigid friction increasing tip 508 generally corresponds to the shape of the nub 506, although the friction increasing tip 508 may be longer than the nub 506. The friction increasing tip 508 may be formed of a rigid material, such as hard plastic. The friction increasing tip 508 may include a friction surface 510 (e.g., a surface that is textured so as to increase a friction applied by the modular fingertip as compared to a base of the soft robotic actuator or an untextured surface). The friction surface 510 may be recessed by being set back from the plane of the base 102, towards the interior of the actuator 202. On the outer perimeter of the friction increasing tip 508, a ledge 512 may extend from friction surface 510 to the plane of the base 102. The same shape may be applied the a soft nub 506.

FIG. 5C depicts three examples of finger extensions 514. The finger extensions 514 represent relatively long and narrow modular tips suitable for being inserted into narrow spaces—for example, the spaces between cylindrical grasping targets such as hot dogs, bread rolls, cucumbers, etc.

The finger extensions 514 may be flat, extending in the plane of the base 102. They may be relatively thin (e.g., at most 25% of the depth of the base of the finger extension 514, preferably at., most 15% of the depth, more preferably at most 10% of the depth). The finger extensions 514 may have a length depending on the application, but are preferably relatively long (e.g., at least 10% of the length of the base 102 of the actuator 202, preferably at least 20% of the length of the base 102, more preferably at least 25% of the length of the base 102).

The finger extension 514 may be the same width along its entire length, or the width may vary as shown in the central drawing and the right drawing.

In the central drawing, the finger extension 514 includes a flat surface that extends away from the soft robotic actuator along a plane defined by a base of the soft robotic actuator, where the extension tapers along its length. In particular, the finger extension 514 includes a first area closest to the distal end 110 of the actuator 202 that is substantially the same width as the base of the finger extension 514. In a second, intermediate area, the width tapers (with the outer edges flared inwards at about a 45 degree angle, in this case, although other angles may be used depending on the application). In a third area at the distal end of the finger extension 514, the width is relatively narrow (e.g., less than 100% of the width in the first area, preferably at most 50% of the width, and more preferably at most 25% the width).

In the drawing on the right, the finger extension 514 includes a flat surface that extends away from the soft robotic actuator along a plane defined by a base of the soft robotic actuator, where the extension widens along its length. In particular, the finger extension 514 includes a first area closest to the distal end 110 of the actuator 202 that is substantially the same width as the base of the finger extension 514 (or, this area may be narrower than the base, in some embodiments). In a second, distal area, the width expands (with the outer edges flared outwards at about a 90 degree angle, in this case, although other angles may be used depending on the application). The width in the second area may be relatively broad (e.g., more than 100% of the width in the first area, preferably at least 110% of the width, and more preferably at least 125% the width).

In another embodiment depicted in FIG. 5D, multiple actuator 202 may be connected by a single modular fingertip 204. In this example, three actuators 202 are connected to finger webbing 516. Such an embodiment may be useful for spreading out the force exerted by the actuator tips (e.g., when picking up delicate items such as bread). The example shown in FIG. 5D includes a webbing tip 518 suitable for scooping items, whereas the example shown in FIG. 5E and FIG. 5F includes pitched tips that would be suitable for picking up items such as sauce bags.

As shown in these Figures, a webbing extension 520 represents an area of the modular fingertip 204 that extends from the base 102 similar to the first area in FIG. 5C. The webbing extension 520 extends to the webbing tip 518, which is angled at, about ninety degrees in FIG. 5D and about 45 degrees in FIG. 5E and FIG. 5F.

In some embodiments, as shown in FIG. 5D, the actuators 202 are separated, resulting in a gap between the bases of the finger webbing 516. Consequently, webbing connectors 522 may be provided between the webbing extensions 520. In embodiments such as the one shown in FIG. 5E and FIG. 5F, the actuators 202 may be relatively closely spaced, and so no webbing extensions 520 (or minimal webbing extensions 520) may be used.

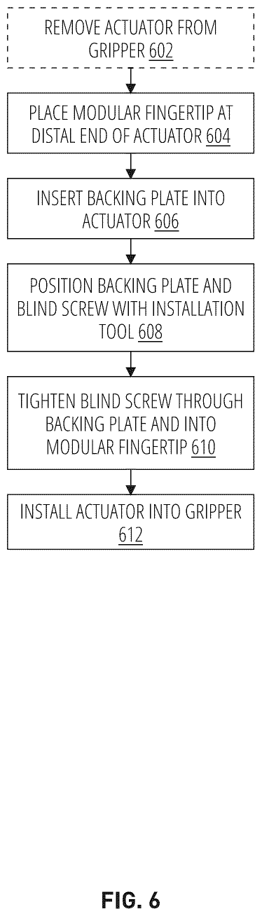

FIG. 6 is a flowchart describing a method for deploying an actuator 202 with a modular fingertip 204.

At block 602, an existing actuator may be removed from a robotic gripper. The existing actuator may be a conventional hard or soft actuator, or may be an actuator 202 such as the one described above. Because the proximal end 112 of the actuators 202 described herein may be the same as the proximal end 112 of conventional soft robotic actuators, exemplary actuators 202 can replace conventional actuators on a one-for-one basis without modifying existing grippers. The existing actuator may be removed in any manner that is suitable to the style of the actuator currently deployed on the gripper (e.g., detaching the actuator base from the gripper via a release or retention mechanism).

In block 604, the modular fingertip may be placed at the distal end of the actuator. The actuator tip and the modular fingertip have corresponding shapes and sizes, and so may be aligned based on their similarities. The gripping surface of the modular fingertip may be aligned to the inside portion of the actuator (the side including the base).

In block 606, a backing plate may be inserted into the actuator (if the actuator does not include an integrated backing plate, which can be used in some embodiments). The backing plate may be inserted through the proximal end of the actuator and maneuvered into the distal end (e.g., using the above-described installation tool). The backing plate may be pushed into the distal end and aligned with a flat surface of the actuator on the internal side of the bottom of the reservoir.

In block 608, the blind screw may be inserted into the reservoir in the same manner as the backing plate with the installation tool. The blind screw may be pushed into an opening in the backing plate.

In block 610, the blind screw may be tightened to drive it through the backing plate, the material of the actuator, and into modular fingertip. The blind screw and/or the corresponding hole in modular fingertip may be sized so that it can be driven only part of the way into the modular fingertip without extending all the way through.

In some embodiments, two or more blind screws may be used, in which case blocks 608 and 610 may be repeated.

In block 612, the now-assembled actuator, may be installed onto the gripper. The actuator may be installed using any suitable mechanism, such as by affixing a hub to the proximal end 112 of the actuator, applying a quick-change or compression attachment mechanism, etc.

The flowchart of FIG. 6 describes a technique for deploying an actuator with a modular fingertip that is connected through the inside of the actuator. One of ordinary skill in the art will recognize how this process can be modified for other configurations, such as where the blind screw is installed from the outside through the modular fingertip.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A soft robotic actuator system comprising:
a soft robotic actuator comprising an elastomeric material extending from a proximal end to a distal end and substantially surrounding a reservoir configured to receive an inflation fluid, the soft robotic actuator configured to bend in a circumferential direction upon adding the inflation fluid to, or removing the inflation fluid from, the reservoir, wherein
the distal end of the actuator is sized and shaped to mate with a proximal end of a modular fingertip configured to be secured onto the distal end of the actuator, and
the distal end comprises one or more holes configured to receive a fastener that mates with the modular fingertip.

2. The soft robotic actuator system of claim 1, further comprising the modular fingertip.

3. The soft robotic actuator system of claim 2, wherein the modular fingertip is a spatula having a substantially flat surface that extends away from the soft robotic actuator along a plane defined by a base of the soft robotic actuator.

4. The soft robotic actuator system of claim 2, wherein the modular fingertip comprises an angled tip that extends away from the soft robotic actuator at an angle to a plane defined by a base of the soft robotic actuator.

5. The soft robotic actuator system of claim 2, wherein the modular fingertip comprises a surface that is textured so as to increase a friction applied by the modular fingertip as compared to a base of the soft robotic actuator.

6. The soft robotic actuator system of claim 2, wherein the modular fingertip comprises a flat extension with a flat surface that extends away from the soft robotic actuator along a plane defined by a base of the soft robotic actuator, wherein the flat extension either tapers or expands along a length of the flat extension.

7. The soft robotic actuator system of claim 2, wherein the modular fingertip is a first modular fingertip that connects to a second adjacent modular finger via inter-fingertip webbing.

8. The soft robotic actuator system of claim 1, wherein the one or more holes of the distal end do not extend completely through the elastomeric material of the soft robotic actuator.

9. The soft robotic actuator system of claim 1, further comprising a backing plate configured to secure the proximal end of the modular fingertip to the distal end of the actuator.

10. The soft robotic actuator system of claim 1, further comprising an ingress seal bead configured to protect an interface between the proximal end of the modular fingertip and the distal end of the actuator.

11. A method comprising:
accessing the soft robotic actuator of claim 1, and
securing the modular fingertip to the distal end of the actuator with a fastener.

12. The method of claim 11, wherein securing the modular fingertip comprises inserting an installation tool into the proximal end of the actuator.

13. The method of claim 12, wherein the installation tool has a length greater than a length of the actuator and a width smaller than a width of the reservoir.

14. The method of claim 12, wherein inserting the installation tool into the proximal end of the actuator comprises lowering the actuator onto the installation tool.

15. The method of claim 11, further comprising inserting a backing plate into the reservoir of the soft robotic actuator prior to securing the modular fingertip with the fastener.

16. The method of claim 15, wherein the fastener is driven through a hole in the backing plate that is matched to a hole in the actuator.

17. The method of claim 11, wherein securing the modular fingertip to the distal end of the actuator comprises inserting the fastener into a hole in the modular fingertip and tightening the fastener.

18. The method of claim 17, further comprising installing an ingress seal between the fastener and the modular fingertip.

19. The method of claim 11, wherein accessing the actuator comprises removing the actuator from a robotic gripper prior to securing the modular fingertip.

20. The method of claim 11, further comprising securing the actuator to a robotic gripper after securing the modular fingertip.
